(19) United States
(12) Patent Application Publication
(10) Pub. No.: US 2016/0266802 A1
(43) Pub. Date: Sep. 15, 2016

(54) STORAGE DEVICE, MEMORY SYSTEM AND METHOD OF MANAGING DATA

(71) Applicant: KABUSHIKI KAISHA TOSHIBA, Minato-ku (JP)

(72) Inventors: Norikazu YOSHIDA, Kawasaki (JP); Youhei KOUCHI, Akishima (JP)

(73) Assignee: KABUSHIKI KAISHA TOSHIBA, Minato-ku (JP)

(21) Appl. No.: 14/825,370

(22) Filed: Aug. 13, 2015

Related U.S. Application Data
(60) Provisional application No. 62/130,936, filed on Mar. 10, 2015.

(51) Int. Cl. G06F 3/06

(52) U.S. Cl. CPC G06F 3/0604; G06F 3/0647; G06F 3/0688

(57) ABSTRACT

According to one embodiment, a storage device includes a first nonvolatile memory having first and second physical addresses, a first controller controlling the first nonvolatile memory and storing data associated with a first memory space which is manageable by itself, the first memory space including the first, second and third physical addresses, a second nonvolatile memory having third and fourth physical addresses, a second controller controlling the second nonvolatile memory and storing data associated with a second memory space which is manageable by itself, the second memory space including the second, third and fourth physical addresses, and a signal line connected between the first and second controller.

### CROSS-REFERENCE TO RELATED APPLICATIONS

This application claims the benefit of U.S. Provisional Application No. 62/130,936, filed Mar. 10, 2015, the entire contents of which are incorporated herein by reference.

### FIELD

Embodiments described herein relate generally to a storage device, a memory system, and a method of managing data.

### BACKGROUND

In a memory system in which a plurality of storage devices are connected to a host, each storage device manages a unique memory space using a unique controller. In this case, since the host must manage these storage devices, the load on it is heavy. As a countermeasure, it is possible to employ a redundant-array-of-inexpensive-disks (RAID) controller that can collectively control the plurality of storage devices as one device. In this case, however, the cost of the memory system is increased by the use of the RAID controller.

### BRIEF DESCRIPTION OF THE DRAWINGS

FIG. 1 is a diagram showing an example of a memory system;

FIGS. 2 and 3 are diagrams showing the outline of a memory space according to an embodiment;

FIG. 4 shows a first flow example of processing executed in a host and a storage device;

FIGS. 5 and 6 are flowcharts for explaining a data management method employed in the processing flow shown in FIG. 4;

FIG. 7 is a diagram showing a second flow example of processing executed in the host and the storage device;

FIGS. 8 and 9 are flowcharts for explaining a data management method employed in the processing flow shown in FIG. 7;

FIG. 10 is a diagram showing an example of application to a memory system comprising a plurality of SSDs;

FIG. 11 is a diagram showing an example of a NAND flash memory; and

FIGS. 12 and 13 are diagrams showing the outline of a memory space employed in the system of FIG. 10.

### DETAILED DESCRIPTION

In general, according to one embodiment, a storage device comprises: a first nonvolatile memory having first and second physical addresses; a first controller controlling the first nonvolatile memory and storing data associated with a first memory space which is manageable by itself, the first memory space including the first, second and third physical addresses; a second nonvolatile memory having third and fourth physical addresses; a second controller controlling the second nonvolatile memory and storing data associated with a second memory space which is manageable by itself, the second memory space including the second, third and fourth physical addresses; and a signal line connected between the first and second controller.

### 1. Embodiment

### (1) System Configuration

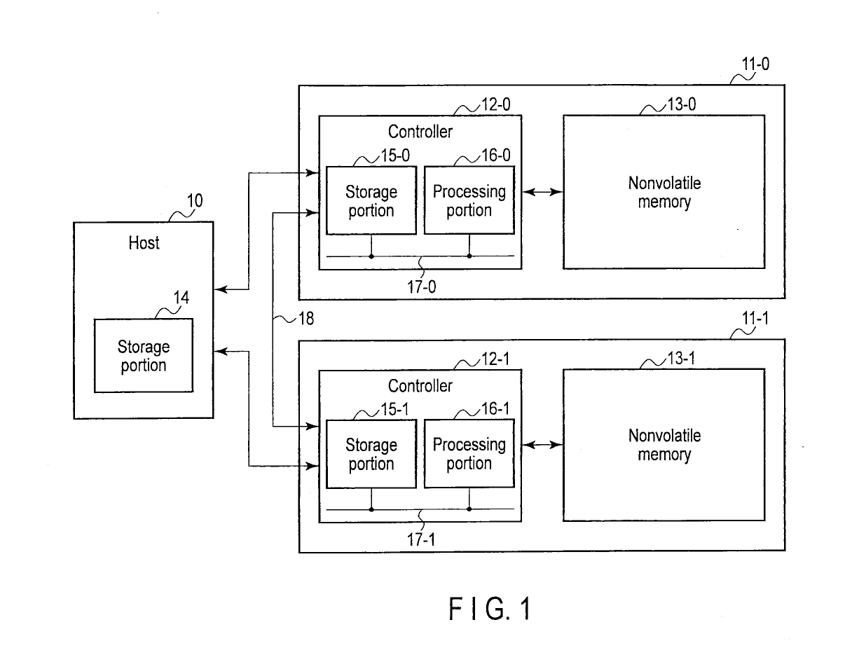

FIG. 1 shows an example of a memory system.

The memory system comprises a host 10, and a plurality of storage devices 111-0 and 11-1 connected to the system. Although in the embodiment, two storage devices 11-0 and 11-1 are connected to the host 10, the number of the devices is not limited to it.

The host 10 controls read/write with respect to a plurality of storage devices 11-0 and 11-1. The host 10 further comprises a storage portion 14. The storage portion 14 is, for example, a volatile memory, such as a dynamic random access memory (DRAM) or a static random access memory (SRAM). In the embodiment, the storage portion 14 is provided within the host 10. However, it may be provided outside the host 10.

It is sufficient if storage devices 11-0 and 11-1 are devices that can store data in a nonvolatile manner. Each of storage devices 11-0 and 11-1 is, for example, a solid-state drive (SSD) or a storage server that uses a nonvolatile semiconductor memory.

Storage device 11-0 comprises controller 12-0 and nonvolatile memory 13-0. Controller 12-0 controls the operation of nonvolatile memory 13-0. Similarly, storage device 11-1 comprises controller 12-1 and nonvolatile memory 13-1. Controller 12-1 controls the operation of nonvolatile memory 13-1. Nonvolatile memories 13-0 and 13-1 are NAND flash memories, for example.

Controller 12-0 comprises storage portion 15-0, processing portion 16-0, and bus 17-0 that connects them. Controller 12-0 is incorporated in, for example, a system-on-chip (SOC). Storage portion 15-0 is a volatile memory, such as a DRAM or an SRAM. Processing portion 16-0 comprises a CMOS logic circuit, and performs, for example, computation.

Similarly, controller 12-1 comprises storage portion 15-1, processing portion 16-1, and bus 17-1 that connects them. Controller 12-1 is incorporated in, for example, a system-on-chip (SOC). Storage portion 15-1 is a volatile memory, such as a DRAM or an SRAM. Processing portion 16-1 comprises a CMOS logic circuit, and performs, for example, computation.

An exclusive signal line 18 connects controllers 12-0 and 12-1. The exclusive signal line 18 is used to transfer data between storage devices 11-0 and 11-1.

The exclusive signal line 18 is also used for transfer of a predetermined command issued by the host 10, transfer of access data to a memory space associated with the predetermined command, etc., as will be described later.

The memory space denotes a memory area to that the host 10 is accessible and includes physical addresses of the storage devices 11-0 and 11-1 (the nonvolatile memories 13-0 and 13-1).

The memory space of the storage devices 11-0 (the nonvolatile memories 13-0) is managed by the controller 12-0 and management data thereof is communicated to the host 10 as resource data. The memory space of the storage devices 11-1 (the nonvolatile memories 13-1) is managed by the controller 12-1 and management data thereof is communicated to the host 10 as resource data.

The host 10 manages a mapping between logical addresses and the physical addresses by using, for example, a memory management unit (MMU).

### (2) Memory Space

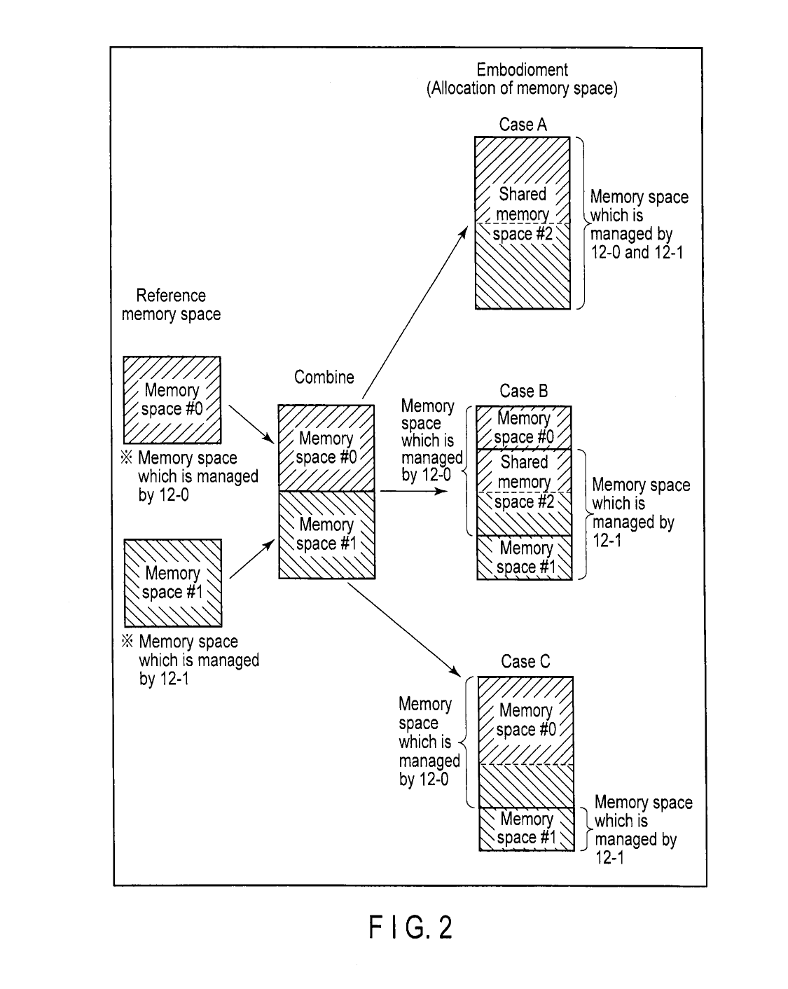

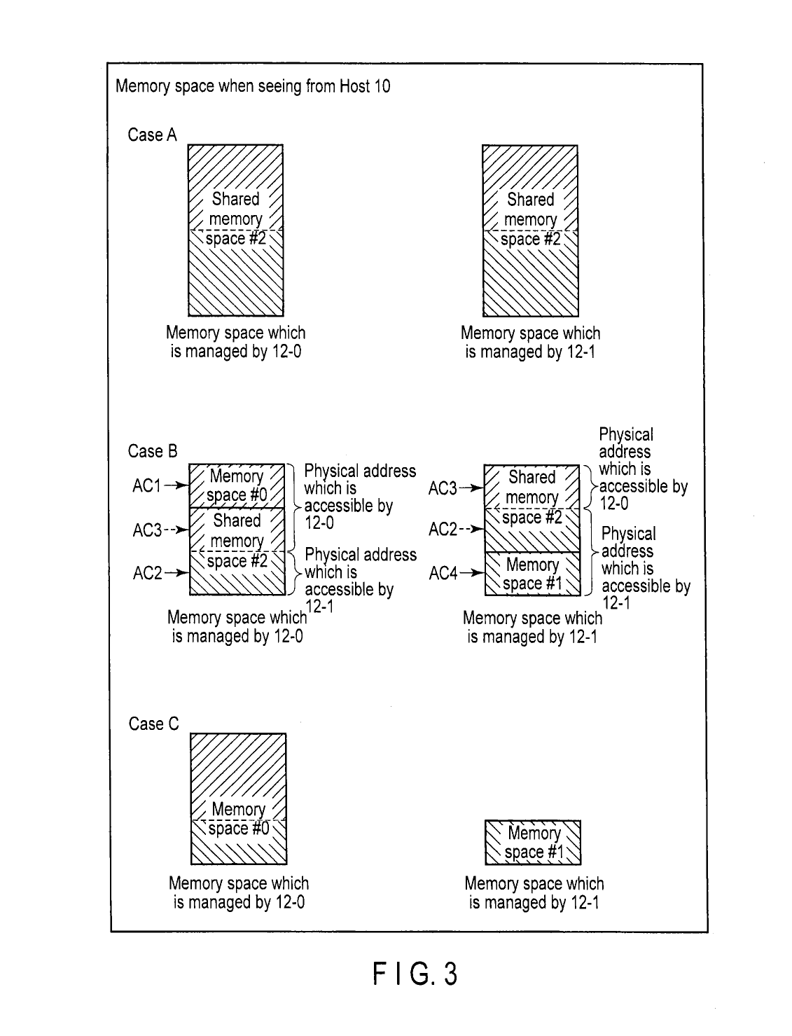

FIGS. 2 and 3 show the outline of a memory space.

Firstly, a presuppositional technique will be described briefly.

For example, in the memory system of FIG. 1, supposing that the memory space of storage device 11-0 is #0, and the memory space of storage device 11-1 is #1, these memory spaces #0 and #1 are generally independent of each other. Namely, memory space #0 is independently managed by controller 12-0, and memory space #0 is independently managed by controller 12-0 (the reference memory space).

Thus, in managing data, the host 10 must handle storage devices 11-0 and 11-1. This means that an excessive load is imposed on the host 10 for data management.

A technique of collectively controlling a plurality of storage devices 11-0 and 11-1 using a RAID controller is known. According to this technique, the host 10 can recognize a plurality of memory space #0 and #1 as the memory space of one device. Accordingly, the load on the host 10 during data management can be reduced.

However, in this case, the RAID controller is added in the memory system, which inevitably increases the cost of the memory system.

In view of this, in the embodiment described below, part of memory spaces #0 and #1 or the entire memory spaces are commoditized, and shared memory space (shared resource) #2 is newly provided.

Further, data associated with memory spaces (independent resources) #0 and #1 managed by a single controller, and data associated with shared resource #2, are stored in storage devices 11-0 and 11-1.

In this case, the resource sizes of storage devices 11-0 and 11-1 can be changed in a scalable manner by sharing access data from the host 10 between storage devices 11-0 and 11-1.

The memory spaces according to the embodiment will now be described. However, it should be noted that the shown spaces are just images for enabling the description to be easily understood.

Firstly, as shown in the figure, a plurality of memory spaces #0 and #1 are combined into a new memory space.

The single new memory space is allocated to at least memory space #0 managed by controller 12-0, memory space #1 managed by controller 12-1, or shared memory space #2 managed by controllers 12-0 and 12-1.

For example, in case A of FIG. 2, all memory spaces are allocated to shared memory space #2 managed by controllers 12-0 and 12-1. A diagonally-right-up hatched area corresponds to memory space #0 in the reference memory space, while a diagonally-left-up hatched area corresponds to memory space #1 in the reference memory space.

In this case, the memory space managed by controller 12-0 is the shared memory space #2, when viewed from the host 10, as is shown in case A of FIG. 3.

Shared memory space #2 is a union of memory spaces #0 and #1 in the reference memory space. Accordingly, when viewed from the host 10, the memory space managed by controller 12-0 will increase substantially.

Similarly, the memory space managed by controller 12-1 is also the shared memory space #2, when viewed from the host 10, as is shown in case A of FIG. 3.

Since shared memory space #2 is a union of memory spaces #0 and #1 in the reference memory space, the memory space managed by controller 12-1 will increase substantially, when viewed from the host 10.

Case A of FIG. 3 provides an advantage that if, for example, only one of controllers 12-0 and 12-1 has been accessed by the host, the size of the memory region (resource) managed by the controller accessed by the host is apparently twice that of the conventional case.

In case B of FIG. 2, part of memory space #0 (diagonally-right-up hatched area) in the reference memory space is allocated to memory space #0 managed by controller 12-0, and the remaining part is allocated to shared memory space #2 controlled by controllers 12-0 and 12-1.

Further, part of memory space #1 (diagonally-left-up hatched area) in the reference memory space is allocated to memory space #1 managed by controller 12-1, and the remaining part is allocated to shared memory space #2 controlled by controllers 12-0 and 12-1.

In this case, the memory space managed by controller 12-0 is a union of memory space #0 and shared memory space #2, when viewed from the host 10, as is shown in case B of FIG. 3. Namely, the memory space managed by controller 12-0 is larger than memory space #0 in the reference memory space. Thus, when viewed from the host 10, the memory space managed by controller 12-0 will increase substantially.

Similarly, the memory space managed by controller 12-1 is a union of memory space #1 and shared memory space #2, when viewed from the host 10, as is shown in case B of FIG. 3. Namely, the memory space managed by controller 12-1 is larger than memory space #1 in the reference memory space. Thus, when viewed from the host 10, the memory space managed by controller 12-1 will increase substantially.

In case C of FIG. 2, entire memory space #0 (diagonally-right-up hatched area) of the reference memory space, and part of memory space #1 (diagonally-left-up hatched area) of the reference memory space, are allocated to memory space #0 managed by the controller 12-0.

Further, the remaining part of memory space #1 in the reference memory space is allocated to memory space #1 managed by the controller 12-1.

In this case, the memory space managed by controller 12-0 is memory space #0, and the memory space managed by controller 12-1 is memory space #1, when viewed from the host 10, as is shown in case C of FIG. 3. Namely, the memory space managed by controller 12-0 is larger than memory space #0 in the reference memory space. Thus, when viewed from the host 10, the memory space managed by controller 12-0 will increase substantially.

The above means that the sizes of memory spaces (resources) #0 and #1 of storage devices 11-0 and 11-1 can be changed in a scalable manner, when viewed from the host 10. Therefore, the load on the host can be reduced without increasing the cost of the memory system.

It should be noted that when the sizes of memory spaces (resources) #0 and #1 of storage devices 11-0 and 11-1 can be changed in a scalable manner as described above, it is important to store data associated with independent resources #0 and #1 and data associated with shared resource #2 in storage devices 11-0 and 11-1, and to share addresses from the host 10 between storage devices 11-0 and 11-1.

### (3) Data Control Method

A description will be given of a data control method employed in the memory system of FIG. 1.

The data control method described below applies to a case where, for example, a predetermined command is issued from the host 10 to controller 12-0, whereby accesses AC1 and AC2 as shown in case B of FIG. 3 have occurred. Namely, AC1 is an access to a (accessible) first physical address that can be accessed by controller 12-0, and AC2 is an access to a second physical address that can be accessed by controller 12-1.

Accordingly, although the predetermined command is transmitted to controller 12-0, access AC2 to the second physical address must be executed by controller 12-1 through data communication from controller 12-0 to controller 12-1.

Similarly, the following data control method applies to a case where, for example, a predetermined command is issued from the host 10 to controller 12-1, thereby causing accesses AC3 and AC4 as shown in case B of FIG. 3. Namely, AC3 is an access to a third physical address that can be accessed by controller 12-0, and AC4 is an access to a fourth physical address that can be accessed by controller 12-1.

Therefore, although the predetermined command is transmitted to controller 12-1, access AC3 to the third physical address must be performed by controller 12-0 after communication of data from controller 12-1 to controller 12-0.

In this case, as shown in case B of FIG. 3, controller 12-0 comprises a memory space including first, second and third physical addresses (corresponding to accesses AC1, AC2 and AC3) that it can manage, and controller 12-1 comprises a memory space including second, third and fourth physical addresses (corresponding to accesses AC2, AC3 and AC4) that it can manage.

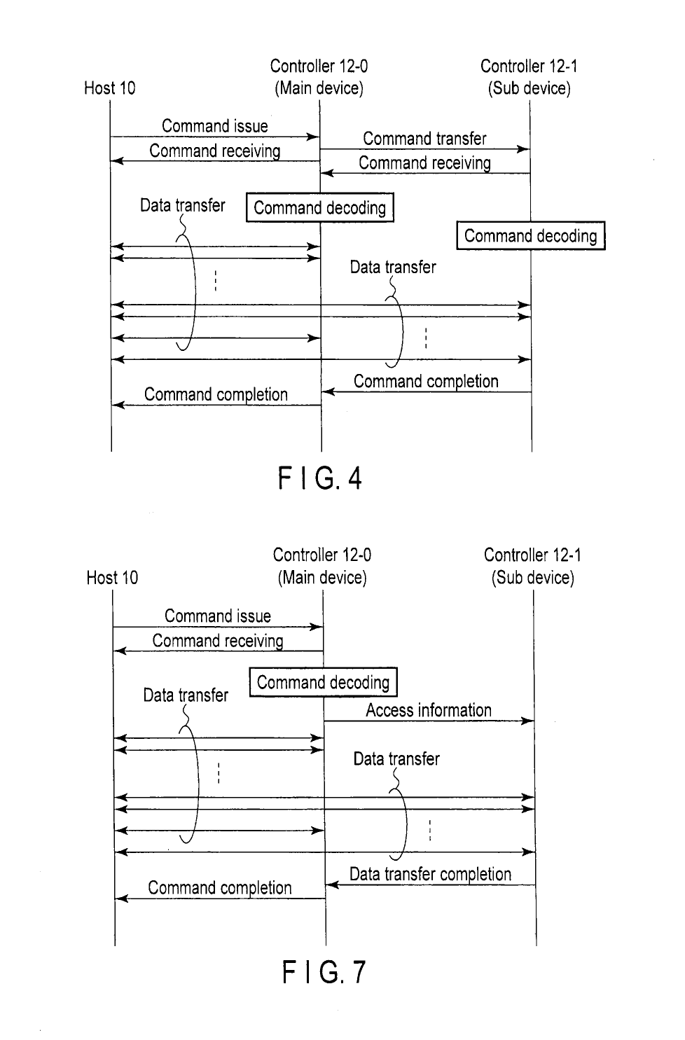

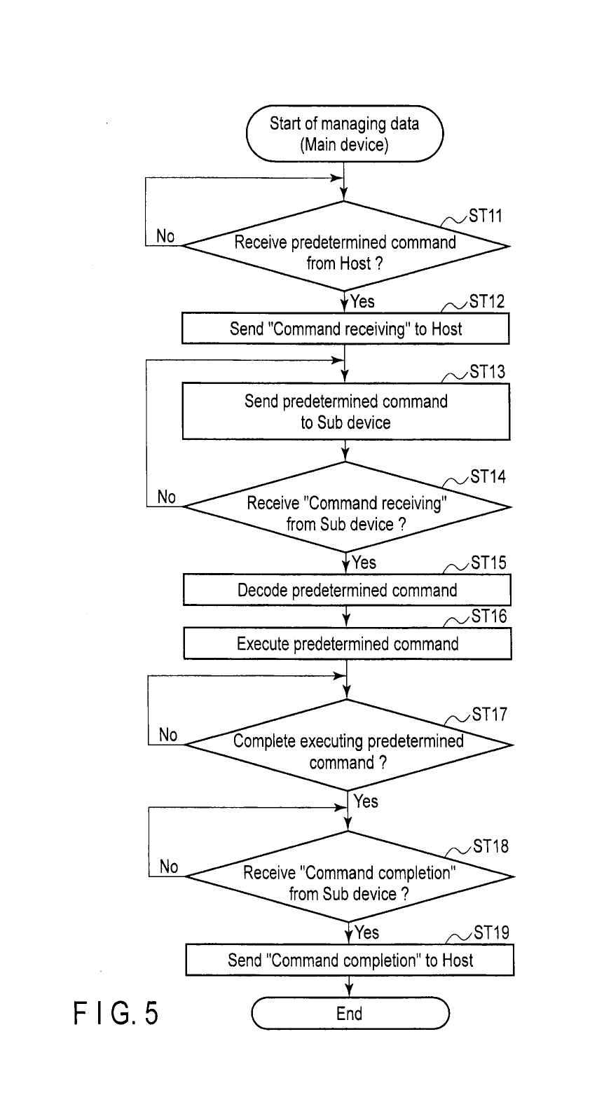

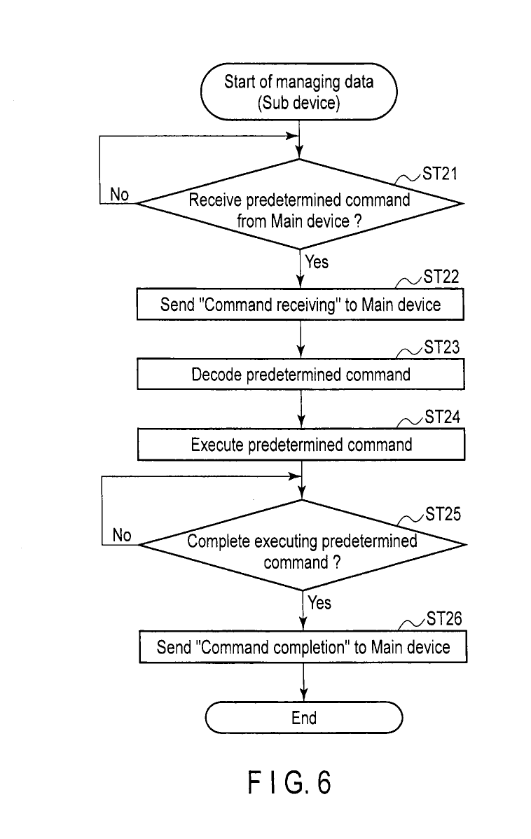

FIG. 4 shows a first example of a processing flow in the host and the storage devices. FIGS. 5 and 6 show a data management method employed in the processing flow of FIG. 4.

FIG. 5 is associated with the operation of controller 12-0 within storage device 11-0, and FIG. 6 shows the operation of controller 12-1 within storage device 11-1.

In the description below, the storage device configured to receive a predetermined command from the host 10 is set to device 11-0 and is referred to as a main device. Further, the storage device, where access occurs in its managed memory space when the predetermined command is executed, is set to storage device 11-1 and is referred to as an auxiliary device.

Firstly, the host 10 issues the predetermined command to storage device (main device) 11-0 (step ST11).

Upon receipt of the predetermined command, controller 12-0 in storage device 11-0 transfers the host 10 with command-receiving data indicating the receipt of the predetermined command, and transfers the predetermined command to controller 12-1 within storage device 11-1 (auxiliary device) via the exclusive signal line 18 of FIG. 1 (steps ST12 to ST14).

Upon receipt of the predetermined command, controller 12-1 in storage device 11-1 transfers the host 10 with command-receiving data indicating the receipt of the predetermined command, and transfers the predetermined command to controller 12-0 (steps ST21 and ST22).

Subsequently, controller 12-0 in storage device 11-0 and controller 12-1 in storage device 11-1 execute fetching and decoding of the predetermined command from the host 10, independently of each other (steps ST15 and ST23).

Moreover, controller 12-0 in storage device 11-0 executes the predetermined command (step ST16).

Namely, controller 12-0 extracts access data corresponding to the memory space (resource) that it manages, and performs an access operation to the memory space in nonvolatile memory 13-0, based on the access data.

The memory space managed by controller 12-0 includes, for example, independent resource #0 and shared resource #2 of FIGS. 2 and 3.

After the access operation of controller 12-0, data transfer is executed between the host 10 and storage device 11-0.

Similarly, controller 12-1 in storage device 11-1 executes the predetermined command (step ST24).

Namely, controller 12-1 extracts access data corresponding to the memory space (resource) that it manages, and performs an access operation to the memory space in nonvolatile memory 13-1, based on the access data.

The memory space managed by controller 12-1 includes, for example, independent resource #1 and shared resource #2 of FIGS. 2 and 3.

After the access operation of controller 12-1, data transfer is executed between the host 10 and storage device 11-1.

Controller 12-0 stores data (resource data) associated with the memory space in, for example, storage portion 15-0 of FIG. 1, in order to extract access data corresponding to the memory space that it manages.

For example, storage portion 15-0 of FIG. 1 stores, as resource data, addresses of the independent resource managed by controller 12-0, and addresses of the shared resource managed by controllers 120-0 and 12-1.

Therefore, controller 12-0 can access its managed independent resource and shared resource, based on the predetermined command (access data) from the host 10.

Similarly, controller 12-1 also stores data (resource data) associated with the memory space in, for example, storage portion 15-1 of FIG. 1 in order to extract access data corresponding to the memory space that it manages.

For example, storage portion 15-1 of FIG. 1 stores, as resources, addresses of the independent resource managed by controller 12-1, and addresses of the shared resource managed by controllers 12-0 and 12-1.

Accordingly, controller 12-1 can access its managed independent resource and shared resource by sharing the predetermined command (access data) from the host 10 between controllers 12-0 and 12-1.

After storage device 11-1 completes processing of the predetermined command, controller 12-1 transfers controller 12-0 with command completion data indicating the completion of processing of the predetermined command, via the exclusive signal line 18 of FIG. 1 (steps ST25 and ST26).

When storage device 11-0 has completed processing of the predetermined command, controller 12-0 transfers the host 10 with command completion data indicating the completion of processing of the predetermined command, on condition that it has received, from controller 12-1, data associated with the command completion (steps ST17 to ST19).

This is the end of the first example of the data control method.

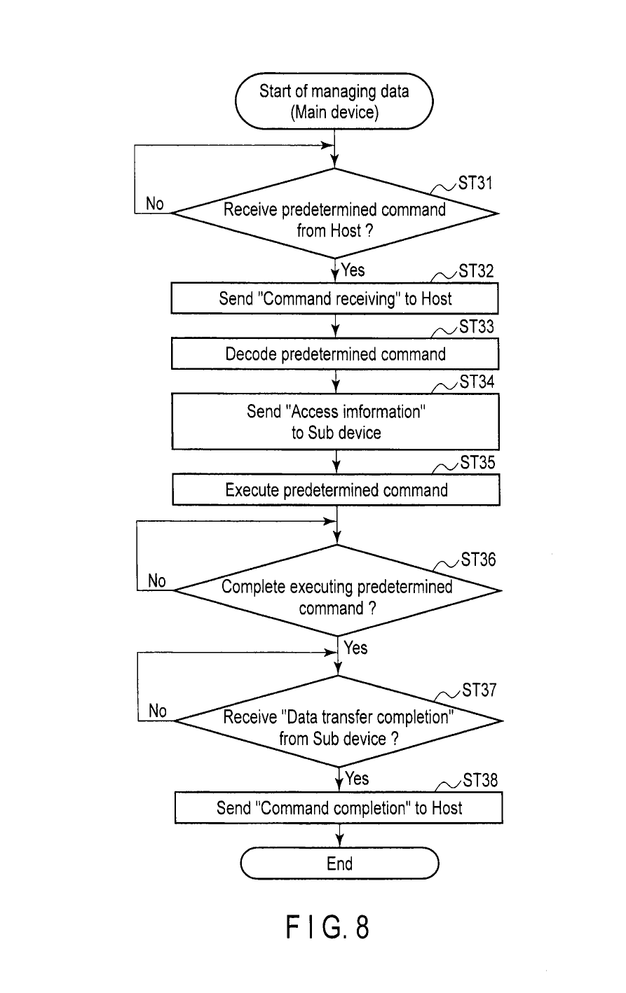

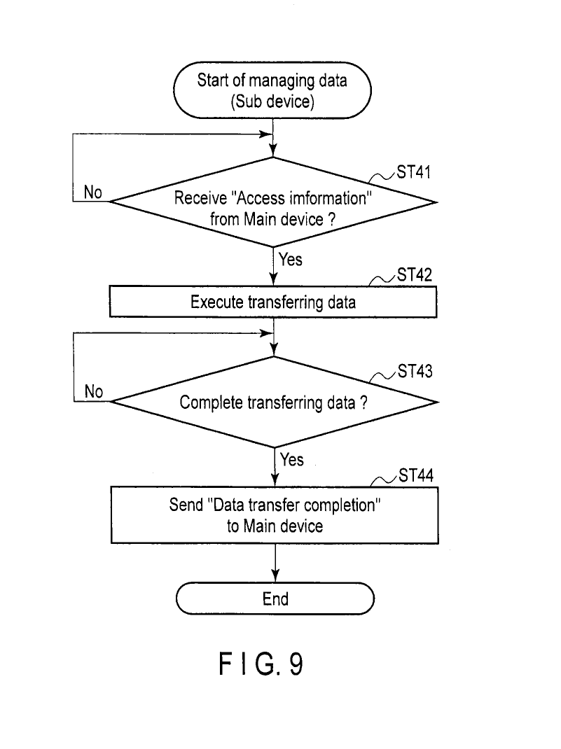

FIG. 7 shows a second example of the processing flow in the host and the storage devices. FIGS. 8 and 9 show a data management method employed in the processing flow of FIG. 7.

FIG. 8 shows the operation of controller 12-0 in storage device 11-0, and FIG. 9 shows the operation of controller 12-1 in storage device 11-1.

In the description below, as in the first example, the storage device configured to receive a predetermined command from the host 10 is set to device 11-0 and is referred to as a main device. Similarly, the storage device, where access occurs in its managed memory space when the predetermined command is executed, is set to storage device 11-1 and is referred to as an auxiliary device.

Firstly, the host 10 issues the predetermined command to storage device (main device) 11-0 (step ST11).

Upon receipt of the predetermined command, controller 12-0 in storage device 11-0 transfers the host 10 with command-receiving data indicating the receipt of the predetermined command (steps ST31 and ST32).

Further, controller 12-0 in storage device 11-0 executes fetching and decoding of the predetermined command from the host 10, independently (step ST33).

If the predetermined command indicates access to a physical address in storage device 11-1, for example, access to a physical address included in shared resource #2 in FIGS. 2 and 3 and accessed by controller 12-1, controller 12-0 transfers access data to controller 12-1 via the exclusive signal line 18 of FIG. 1 (step ST34).

Moreover, controller 12-0 executes the predetermined command (step ST35).

Namely, controller 12-0 extracts access data corresponding to its managed memory space (resource), and performs an access operation to the memory space in nonvolatile memory 13-0, based on the access data.

The memory space managed by controller 12-0 includes, for example, independent resource #0 and shared resource #2 of FIGS. 2 and 3.

After the access operation of controller 12-0, data transfer is executed between the host 10 and storage device 11-0.

On the other hand, upon receipt of the addresses from controller 12-0, controller 12-1 executes an access operation to the memory space in nonvolatile memory 13-1, based on the access data (step ST41).

The memory space managed by controller 12-1 includes, for example, independent resource #1 and shared resource #2 of FIGS. 2 and 3.

After the access operation of controller 12-1, data transfer is executed between the host 10 and storage device 11-1 (step ST42).

In order to extract the access data corresponding to its managed memory space, and the access data corresponding to the memory space managed by controller 12-1, controller 12-0 stores data (resource data) associated with the memory spaces in, for example, storage portion 15-0 of FIG. 1.

For instance, storage portion 15-0 of FIG. 1 stores, as resource data, the addresses of the independent resource managed by controller 12-0, and the shared resource managed by controllers 12-0 and 12-1.

Accordingly, controller 12-0 can access its managed independent resource and shared resource, based on the predetermined command (access data) from the host 10. Further, controller 12-0 can transfer controller 12-1 with addresses corresponding to the shared resource managed by controller 12-1, if there is any.

Similarly, controller 12-1 also stores data (resource data) associated with the memory space in, for example, storage portion 15-1 of FIG. 1, in order to extract access data corresponding to the memory space that it manages.

For instance, storage portion 15-1 of FIG. 1 stores, as resources, addresses of the independent resource managed by controller 12-1, and addresses of the shared resource managed by controllers 12-0 and 12-1.

Accordingly, controller 12-1 can access its managed independent resource and shared resource by sharing access data from the host 10 between controllers 12-0 and 12-1.

When data transfer is completed in storage device 11-1, controller 12-1 transfers controller 12-0 with data-transfer-completion data indicating that data transfer has been completed, via the exclusive signal line 18 of FIG. 1 (steps ST43 and ST44).

When storage device 11-0 has completed processing of the predetermined command, controller 12-0 transfers the host 10 with command completion data indicating the completion of processing of the predetermined command, on condition that it has received, from controller 12-1, data associated with the command completion (steps ST36 to ST38).

This is the end of the second example of the data control method.

In the above-described first example of the data control method, fetching and decoding of the predetermined command from the host 10 are performed in both of storage device 11-0 as the main device and storage device 11-1 as the auxiliary device. The first example is advantageous in that both controllers 12-0 and 12-1 are equalized in processing content.

In contrast, in the second example of the data control method, the fetching and decoding of the predetermined command from the host 10 are performed only in storage device 11-0 as the main device. The second example is advantageous in that the load on controller 12-1 in storage device 11-1 as the auxiliary device is reduced. The second example is also advantageous in that it is not necessary to transfer the predetermined command between controllers 12-0 and 12-1, and it is sufficient if only the necessary addresses are transferred.

### (4) Summary

As described above, in the memory system according to the embodiment, in which a plurality of storage devices (a plurality of controllers) are connected to the host, a shared resource managed by a plurality of controllers is newly provided. Each controller stores data associated with an independent resource, and data associated with a shared resource. In this case, the sizes of the resources managed by each controller can be changed in a scalable manner by sharing access data from the host among the controllers.

Therefore, a controller, such as a RAID controller, for collectively controlling a plurality of storage devices is not necessary, which can suppress the required cost of the memory system. Moreover, the host can recognize a shared memory space (shared resource) as if it is a resource in a single device, and hence the load on the host can also be reduced.

### 2. Applied Example

A description will be given of an example of a data storage device, to which the above-described embodiment is applicable, and an example of a computer system comprising the data storage device.

For example, in standards for PCIe storage devices, such as NVMe standards, data transfer is performed between a host and a storage device, based on resource data in a host-side system memory space. Accordingly, in a memory system where a plurality of storage devices are connected to a host, the host individually recognizes the resource size of each storage device.

In this case, if data associated with independence/shared resources is stored in each storage device and if access data from the host is shared among a plurality of storage devices, as in the above embodiment, the resource data of each storage device can be changed in a scalable manner to thereby reduce the load on the host.

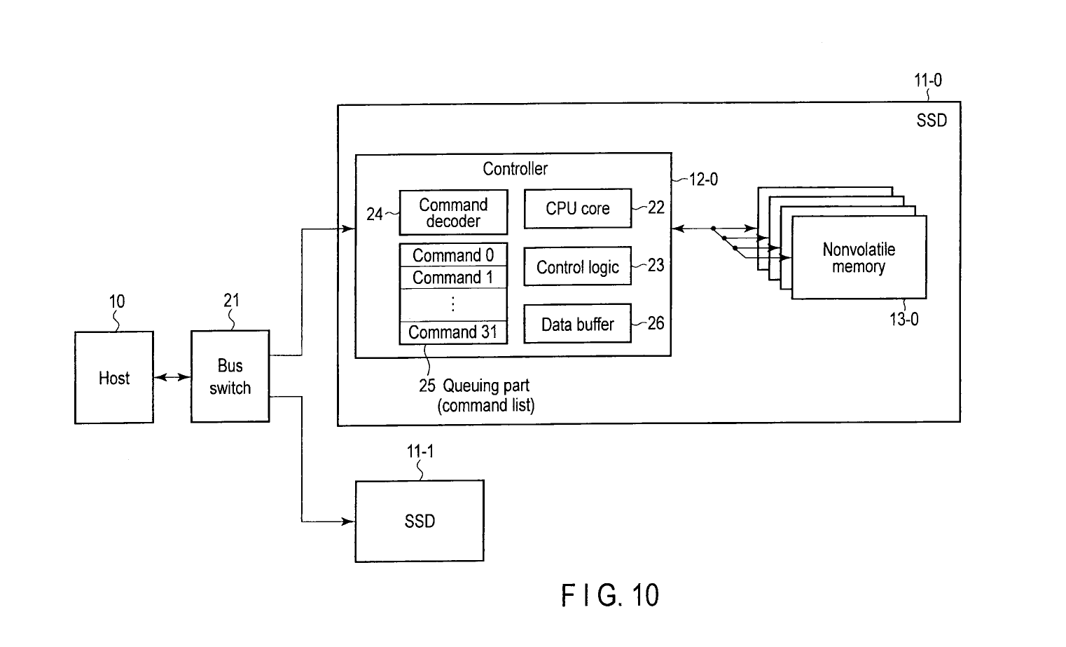

FIG. 10 shows an example of the memory system where a plurality of storage devices are connected to a host.

As shown, data storage devices 11-0 and 11-1 are connected to a host 10 via a bus switch 21.

Data storage devices 11-0 and 11-1 have the same configuration. Therefore, a description will be given to storage device 11-0.

Data storage device 11-0 comprises controller 12-0 and nonvolatile memory 13-0. Nonvolatile memory 13-0 is a NAND flash memory, for example. Controller 12-0 comprises a CPU core 22, a control logic 23, a command decoder 24, a queuing part (command list) 25 and a data buffer (buffer memory) 26.

A plurality of commands transferred from the host 10 are registered in the queuing part 25 in controller 12-0 via the command decoder 24. Further, data associated with the commands is temporarily stored in the data buffer 26. The data buffer 26 is, for example, a DRAM, an SRAM, an MRAM, a ReRAM, etc. Namely, it is sufficient if the data buffer 26 is a random access memory faster than nonvolatile memory 13-0.

The plurality of commands registered in the queuing part 25 are sequentially processed based on tag numbers. The control logic 23 is a logic circuit for executing processing instructed by, for example, the CPU core 22.

The data buffer 26 may be provided outside controller 12-0.

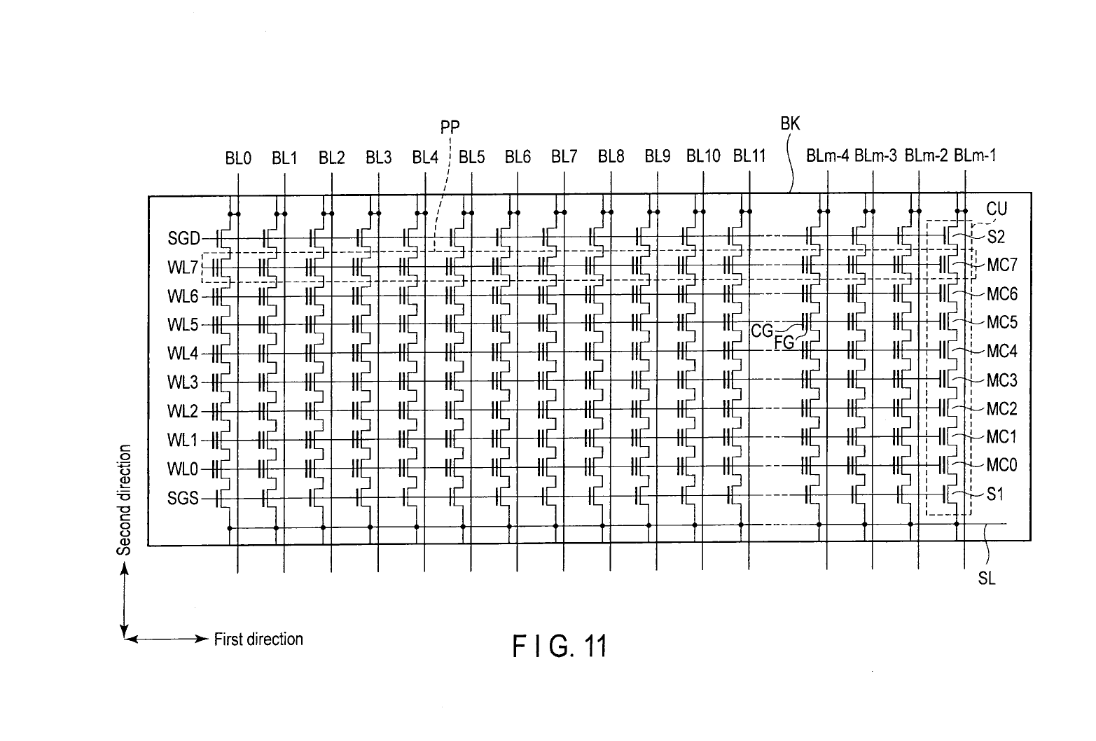

FIG. 11 shows the example of the NAND flash memory.

This NAND flash memory corresponds to nonvolatile memory 13-0 of FIG. 10, for example.

The NAND flash memory has a block BK.

The block BK comprises a plurality of cell units CU arranged in a first direction. Each cell unit comprises a memory cell string extending in a second direction intersecting the first direction, transistor S1 connected to one end of the current path of the memory cell string, and select transistor S2 connected to the other end of the current path of the memory cell string. The memory cell string has eight memory cells MC0 to MC7 having their current paths connected in series.

Each memory cell MCk (k is between 0 and 7) comprises a charge storage layer (for example, a floating gate electrode) FG, and a control gate electrode CG.

Although in this example, each cell unit CU includes eight memory cells MC0 to MC7, it is not limited to this. For example, each cell unit CU may include two or more memory cells, such as 32 or 56 memory cells.

A source line SL is connected to each current path of the memory cell string via corresponding select transistor S1. Bit line BLm-1 is connected to the other end of the current path of a corresponding cell unit of the memory cell string via corresponding select transistor S2.

Word lines WL0 to WL7 are connected in common to the respective control gate electrodes CG of memory cells MC0 to MC7 arranged in the first direction. Similarly, a select gate line SGS is connected in common to the gate electrodes of the plurality of select transistors S1 arranged in the 1st direction, and a select gate line SGD is connected in common to the gate electrodes of the plurality of select transistors S2 arranged in the first direction.

One physical page PP comprises m memory cells connected to one word line WLi (i is between 0 and 7).

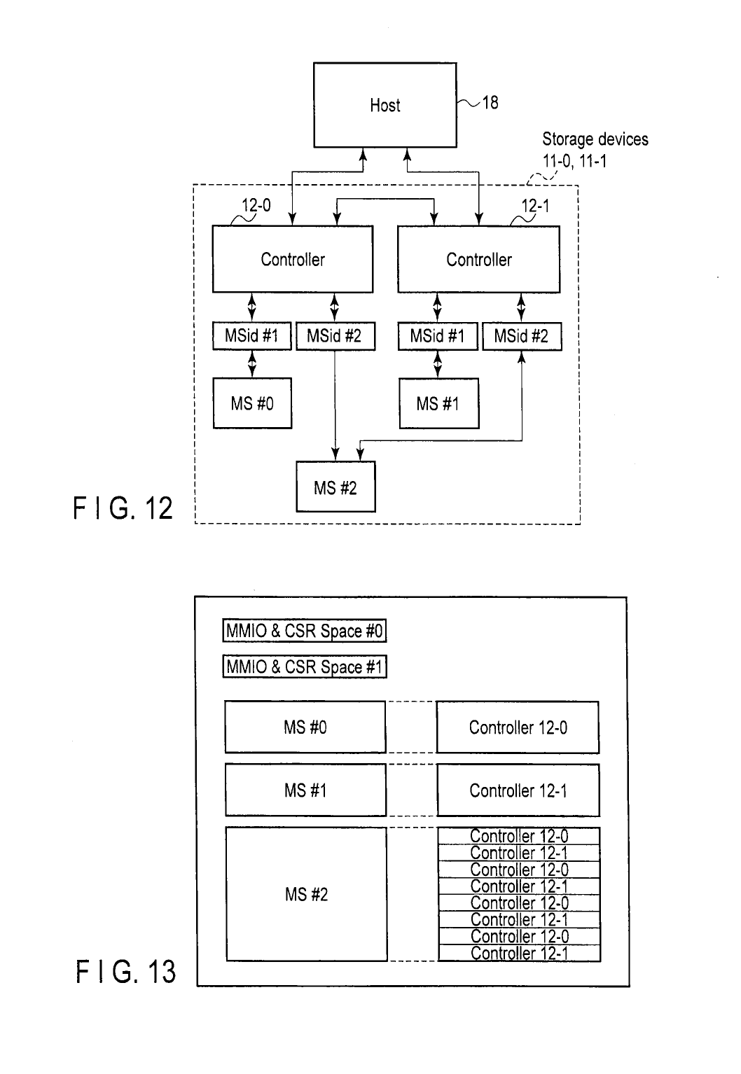

FIGS. 12 and 13 show an example of a memory space (resource) recognized by the host of the memory system of FIG. 10.

The host 10 and controllers 12-0 and 12-1 shown in FIG. 12 correspond to, for example, the host 10 and controllers 12-0 and 12-1 shown in FIGS. 1 and 10.

MS#0, MS#1 and MS#2 are memory spaces, and refer to areas that store data to which names for discriminating similar programs and/or documents from each other are attached.

In this example, the host 10 stores, in its own system memory, resource data indicating that the memory spaces managed by controller 12-0 are MS#0 and MS#2. The host 10 also stores, in its own system memory, resource data indicating that the memory spaces managed by controller 12-1 are MS#1 and MS#2.

Namely, MS#2 is a shared memory space managed by controllers 12-0 and 12-1.

Controller 12-0 and 12-1 store data associated with the resources they manage.

More specifically, controller 12-0 stores data MSid (memory space identifier) #0 indicating that controller 12-0 itself manages MS#0 as an independent resource, and data MSid (memory space identifier) #2 indicating that controller 12-0 itself manages MS#2 as a shared resource.

Similarly, controller 12-1 stores data MSid (memory space identifier) #1 indicating that controller 12-1 itself manages MS#1 as an independent resource, and data MSid (memory space identifier) #2 indicating that controller 12-1 itself manages MS#2 as the shared resource.

In this case, the host 10 recognizes memory spaces as shown in FIG. 13.

FIG. 13 shows that MS#0 is managed by controller 12-0, MS#1 is managed by controller 12-1, and MS#2 is managed by controller 12-0 or 12-1.

MMIO & CSR space #0 refers to a memory (memory mapped I/O [MMIO]) space for storing a command or an address for enabling the host 10 to access storage device 11-0, and a memory space (control and status registers space: CSR space) for storing data associated with control/status of storage device 11-0.

MMIO & CSR space #1 refers to a memory (memory mapped I/O [MID]) space for storing a command or an address for enabling the host 10 to access storage device 11-1, and a memory space (control and status registers space: CSR space) for storing data associated with control/status of storage device 11-1.

### 3. Conclusion

As described above, in the memory system of the embodiment wherein a plurality of storage devices (a plurality of controllers) are connected to a host, a shared resource managed by a plurality of controllers is newly prepared. Each controller stores data associated with an independent resource, and data associated with a shared resource. In this case, the sizes of the resources managed by each controller can be changed in a scalable manner by sharing access data from the host among the controllers.

Therefore, a controller, such as a RAID controller, for collectively controlling a plurality of storage devices is not necessary, which can suppress the required cost of the memory system. Moreover, the host can recognize a shared memory space (shared resource) as if it is a resource in a single device, and hence the load on the host can also be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a first nonvolatile memory having first and second physical addresses;
a first controller controlling the first nonvolatile memory and storing data associated with a first memory space which is manageable by itself, the first memory space including the first, second and third physical addresses;
a second nonvolatile memory having third and fourth physical addresses;
a second controller controlling the second nonvolatile memory and storing data associated with a second memory space which is manageable by itself, the second memory space including the second, third and fourth physical addresses; and
a signal line connected between the first and second controller.

2. The device of claim 1, wherein a memory space including the second and third addresses is a shared memory space managed by the first and second controllers.

3. The device of claim 1, wherein the first controller is configured to transfer a command to the second controller via the signal line, when receiving the command from a host.

4. The device of claim 3, wherein the second controller is configured to:
decode the command transferred from the first controller;
access to the third physical address when the command designates the access to the third physical address; and
transfer first data indicating a completion of the command to the first controller via the signal line when execution of the command is completed.

5. The device of claim 4, wherein the first controller transfers second data indicating the completion of the command to the host when receiving the first data from the second controller.

6. The device of claim 5, wherein the first controller stores address data of the first memory space, and the second controller stores address data of the second memory space.

7. The device of claim 1, wherein the second controller transfers a command to the first controller via the signal line, when receiving the command from a host.

8. The device of claim 7, wherein the first controller is configured to:
decode the command transferred from the second controller;
access to the second physical address when the command designates the access to the second physical address; and
transfer first data indicating a completion of the command to the second controller via the signal line when execution of the command is completed, and
wherein the second controller transfers second data indicating the completion of the command to the host when receiving the first data from the first controller.

9. The device of claim 1, wherein
the first controller is configured to:
decode a command when receiving the command from a host; and
transfer first data indicating an access to the third physical address to the second controller via the signal line when the command designates the access to the third physical address.

10. The device of claim 9, wherein the second controller is configured to:
access to the third physical address based on the first data; and
transfer second data to the first controller via the signal line when the data transfer to or from the third physical address is completed, the second data indicating a completion of data transfer to or from the third physical address.

11. The device of claim 10, wherein the first controller transfers third data indicating a completion of the command to the host when receiving the second data from the second controller.

12. The device of claim 11, wherein the first controller stores address data of the first memory space, and the second controller stores address data of the second memory space.

13. The device of claim 1, wherein the second controller is configured to:
decode a command when receiving the command from a host; and
transfer first data indicating an access to the second physical address to the first controller via the signal line when the command designates the access to the second physical address.

14. The device of claim 13, wherein
the first controller is configured to:
access to the second physical address based on the first data; and
transfer second data to the second controller via the signal line when the data transfer to or from the second physical address is completed, the second data indicating a completion of data transfer to or from the second physical address, and
wherein the second controller is configured to:
transfer third data indicating a completion of the command to the host when receiving the second data from the first controller.

15. A memory system comprising:
a host;
a first storage device connected to the host, the first storage device comprising a first nonvolatile memory having first and second physical addresses and a first controller controlling the first nonvolatile memory, the first controller storing data associated with a first memory space which is manageable by itself, the first memory space including the first, second and third physical addresses;
a second storage device connected to the host, the second storage device comprising a second nonvolatile memory having third and fourth physical addresses and a second controller controlling the second nonvolatile memory, the second controller storing data associated with a second memory space which is manageable by itself, the second memory space including the second, third and fourth physical addresses; and
a signal line connected between the first and second controller.

16. The system of claim 15, wherein a memory space including the second and third addresses is a shared memory space managed by the first and second controllers.

17. A method of managing data using the storage device of claim 1, the method comprising:
transferring a command from the first controller to the second controller via the signal line when the command is transferred from the host to the first controller;
decoding the command in the second controller;
executing an access to the third physical address when the command designates the access to the third physical address;
transferring first data indicating a completion of the command from the second controller to the first controller via the signal line when the command is completed; and
transferring second data indicating the completion of the command from the first controller to the host on condition that the first data has been transferred from the second controller to the first controller.

18. A method of managing data using the storage device of claim 1, the method comprising:
transferring a command from the second controller to the first controller via the signal line when the command is transferred from the host to the second controller;
decoding the command in the first controller;
executing an access to the second physical address when the command designates the access to the second physical address;
transferring first data indicating a completion of the command from the first controller to the second controller via the signal line when the command is completed; and
transferring second data indicating the completion of the command from the second controller to the host on condition that the first data has been transferred from the first controller to the second controller.

19. A method of managing data using the storage device of claim 1, the method comprising:
decoding a command in the first controller when the command is transferred from the host to the first controller;
transferring first data indicating an access to the third physical address from the first controller to the second controller via the signal line when the command designates the access to the third physical address;
executing an access to the third physical address based on the first data in the second controller;
transferring second data indicating a completion of data transfer from the second controller to the first controller via the signal line when the data transfer to or from the third physical address is completed; and
transferring third data indicating a completion of the command from the second controller to the host on condition that the second data has been transferred from the second controller to the first controller.

20. A method of managing data using the storage device of claim 1, the method comprising:
decoding a command in the second controller when the command is transferred from the host to the second controller;
transferring first data indicating an access to the second physical address from the second controller to the first controller via the signal line when the command designates the access to the second physical address;
executing an access to the second physical address based on the first data in the first controller;
transferring second data indicating a completion of data transfer from the first controller to the second controller via the signal line when data transfer to or from the second physical address is completed; and
transferring third data indicating a completion of the command from the second controller to the host on condition that the second data has been transferred from the first controller to the second controller.
